(19) United States
(12) Patent Application Publication
(10) Pub. No.: US 2017/0011239 A1
(43) Pub. Date: Jan. 12, 2017

(54) SYSTEM AND METHOD FOR REMOTELY MANAGING FUNCTIONS OF A DEVICE

(71) Applicant: Texas Instruments Incorporated, Dallas, TX (US)

(72) Inventors: Trevor Thomas Chapman, Allen, TX (US); James Joseph Galu, JR., Richardson, TX (US); Thomas Brian Olson, Allen, TX (US)

(73) Assignee: Texas Instruments Incorporated, DALLAS, TX (US)

(21) Appl. No.: 15/079,158

(22) Filed: Mar. 24, 2016

Related U.S. Application Data
(60) Provisional application No. 62/189,059, filed on Jul. 6, 2015.

(51) Int. Cl. G06K 7/10

(52) U.S. Cl. CPC G06K 7/10198; G06K 7/10297

(57) ABSTRACT

A system and method is disclosed for remotely managing functional modes of devices. A device may receive commands remotely to initiate a particular functional mode when the device is within the proximity of a given location. The commands may be provided to the device via Radio Frequency Identification (RFID), or proximity based wireless communication networks.

### CROSS-REFERENCE TO RELATED APPLICATIONS

This application claims priority to the U.S. provisional patent application Ser. No. 62/189,059, filed Jul. 6, 2015, the entirety of which is hereby incorporated herein by reference for all purposes.

### TECHNICAL FIELD

This disclosure relates generally to the field of remotely managing functional modes of devices and more particularly to remotely managing functional modes of devices that are within a geographic region.

### BACKGROUND

Handheld devices such as mobile computers, tablets, smartphones, calculators, and others are regularly used in educational institutes to enhance the learning experience of students. Particularly, sophisticated calculators are used by students to help them solve complex problems such as draw graphs, solve multiple orders of equations, and execute various other functions. Calculators with limited functions are also used during exams/test allowing students to solve simple problems while working on complex issues. Many calculators offer a ‘test mode’, which can be manually enabled by students or teachers/proctors. Typically, ‘test mode’ disables a set of calculator functions while allowing students to use other functions of the calculator.

The ‘test mode’ on calculators is indicated with some visible indication, which can be identified by the teacher/proctor to ensure that students are following proper instructions for the exam/test. The ‘test mode’ can be manually disabled by students anytime during the exam/test such as for example, by connecting the calculator to another device (e.g., another calculator, or a computer) and transmitting a message to the calculator, which will cause the calculator to exit the test mode. To avoid such disabling of ‘test mode’, the teacher/proctor must regularly observe ‘test mode’ indicator on all students' calculators to ensure students do not attempt to cheat by disabling the ‘test mode’. Further, it requires teacher/proctor to check every calculator at least once initially to ensure that the ‘test mode’ is enabled, which can take significant amount of time especially, when the class size is large. Therefore, there is a need for a system and method for automated or remote exam mode configuration for calculators and/or to ensure that the same configuration is replicated across all calculators automatically.

### BRIEF DESCRIPTION OF THE DRAWINGS

FIGS. 1A and 1B illustrates an exemplary process for configuring exam mode on calculators using RFIDs according to an embodiment.

FIG. 2 illustrates an exemplary block diagram of a calculator according to an embodiment.

FIG. 3 illustrates an exemplary system for selectively remotely managing functions of devices according to an embodiment.

FIG. 4 illustrates an exemplary flowchart of a process for remotely managing functions of devices according to an embodiment.

### DETAILED DESCRIPTION

The following description provides many different embodiments, or examples, for implementing different features of the subject matter. These descriptions are merely for illustrative purposes and do not limit the scope of the invention.

According to an embodiments, a system and method is disclosed for remotely managing functions of devices and more particularly, managing exam mode configuration of calculators when calculators are within the proximity of exam locations. A calculator may receive remote command to initiate a particular mode on the calculator such as a test mode, when the calculator is within the proximity of exam/test location. The command may be provided to the calculator via wireless communication such as for example using Radio Frequency Identification (RFID), and other proximity based nearfield communication systems.

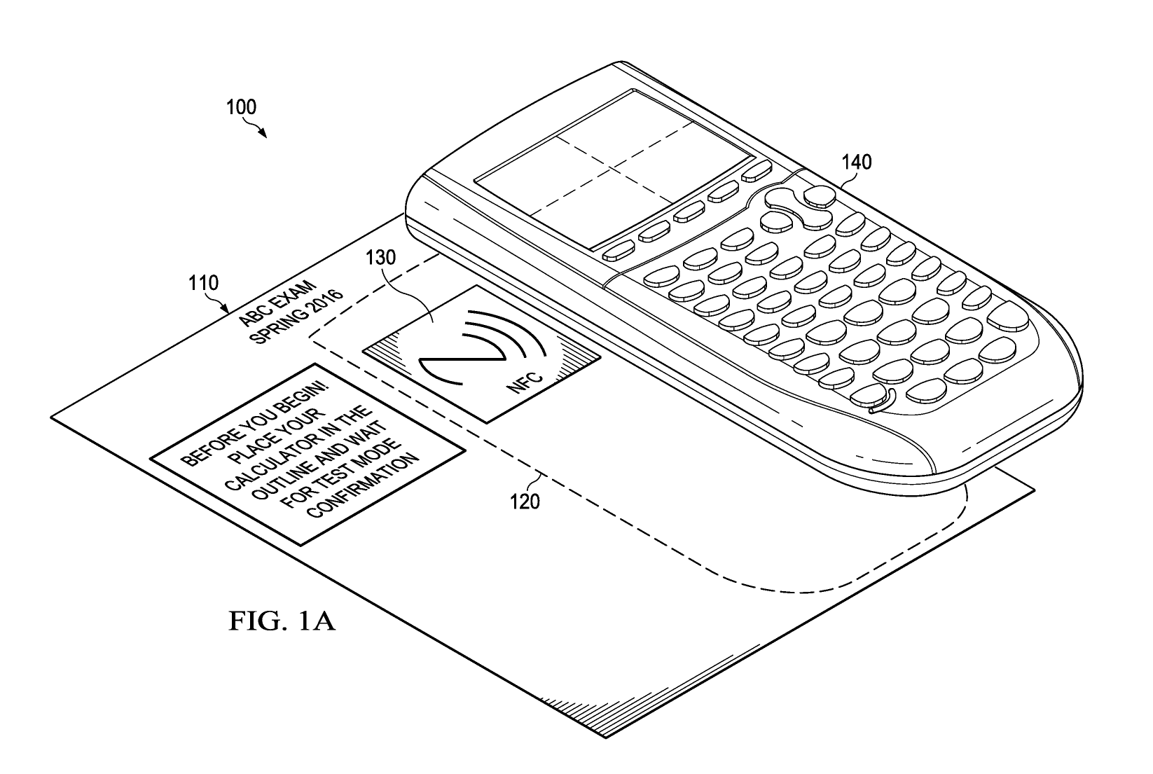

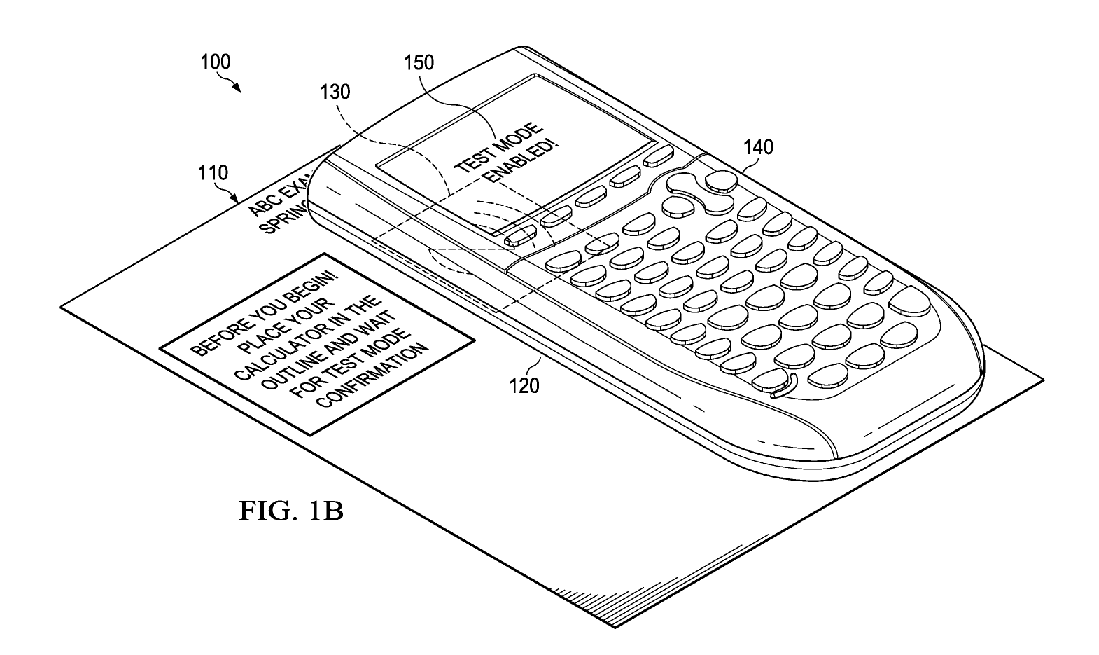

Referring to FIG. 1A and 1B, an exemplary process 100 for configuring exam mode on calculators using RFIDs is illustrated according to an embodiment. An exam book 110 includes an outline 120 with a communication tag 130. In the exemplary embodiment, the communication tag 130 is a Near Field Communication (NFC) tag, such as for example an RFID. The exam book 110 includes instructions for students to place their calculator 140 on the outline 120. Students can be instructed to place calculator on the outline prior to opening the exam book. The calculator 140 may include a transceiver configured to scan and read the RFID tag 130. The RFID tag 130 may be configured to provide commands, instruction, indicator, trigger, or similar signal to calculator 140 to enable a particular functional mode on the calculator 140 such as for example a test mode, thus disabling a subset of functions on the calculator 140. The subset of functions can be predetermined and customized based on the type of exam for example, a Math exam RFID tag may disable certain equation functions and a Finance exam RFID tag may disable certain amortization tables etc.

Referring to FIG. 1B, when the calculator 140 is placed on the outline 120 and the RFID tag 130 is scanned and read by the calculator 140, the calculator 140 may display an indication 150 to indicate that a test mode is turned on. The indication 150 can be in various other forms also such as for example, a particular LED may be turned on, a different LED may start blinking, the color of the display screen of calculator 140 may change, a particular indication bar may appear on the display screen, or similar other indications may be provided.

After the test mode is enabled, students may begin to use the calculator as instructed. The calculator 140 can be configured such to stay in the test mode until a predetermined process is followed. According to an embodiment, the predetermined process may include placing the calculator 140 on a second RFID tag similar to RFID tag 130 (not shown). The second RFID tag can be configured to provide commands, instruction, indicator, trigger, or similar signal to calculator 140 to disable the test mode, thus enabling the subset of functions previously disabled on the calculator 140. This prevents students from manually disabling the test mode on the calculator 140. According to another embodiment, the RFID tags may be placed at the door of the exam location where each student may be required to place calculator 140 on a first RFID tag when they enter the exam location, enabling the test mode. The students then may be required to place the calculator 140 on a second RFID tag when they exit the exam location, disabling the test mode. Similarly, RFID tags may be placed anywhere at the exam location such as for example, on a teacher's desk where each student may be required to stop by and place the calculator 140 on the first and second RFID tags as required.

According to yet another embodiment, RFID tags can be configured to initiate a timer in the calculator 140 while providing commands, instruction, indicator, trigger, or similar signals to enable the test mode. The timer can be configured to disable the test mode after a predetermined period of time. The predetermined period of time can be configured such to allow sufficient time to complete the exam. This may eliminate the need to place calculator 140 on a second RFID tag to disable the test mode. While for exemplary purposes, NFC RFID tags are used; however, any form of proximity based or near field communication methods can be used to provide appropriate commands to calculator 140 such as for example, barcodes, NFC tags, and proximity cards that allows calculator 140 to communicate and exchange digital information simply by being within the proximity of the command generator.

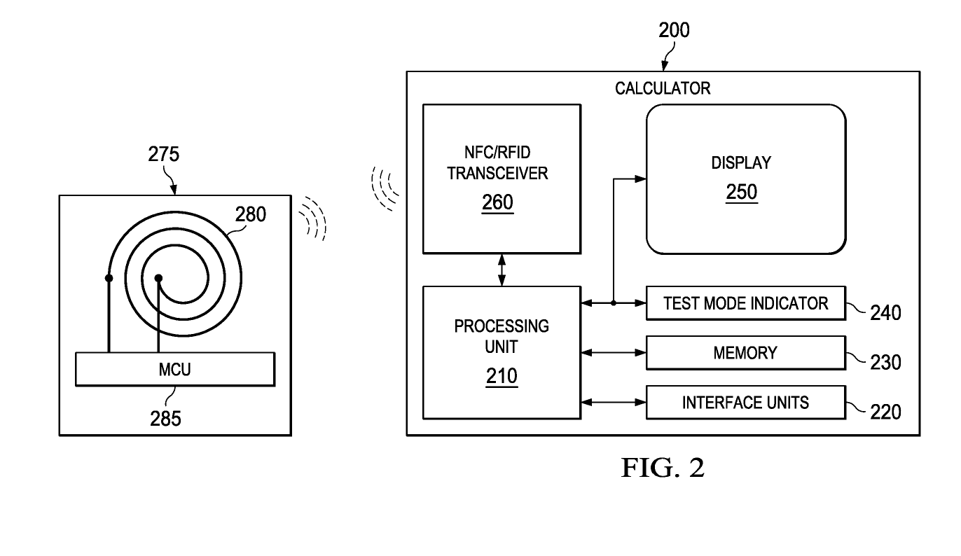

Referring to FIG. 2, an exemplary block diagram of a calculator 200 is illustrated according to an embodiment. Calculator 200 includes a processing unit 210. The processing unit 210 may be configured to execute various calculation functions for example from simple calculations to solving complex equations and scientific functions. While for exemplary purposes, one processing unit 210 is illustrated; however, calculator 200 may include more than one processing unit and may also include various arithmetic logic units or these units may be integrated in various processing units. The calculator 200 further includes various interface units 220. Interface units 220 may include keyboard, serial/parallel communication interfaces, power connectors, power management units, battery interface, and other interface units that may be required for calculator 200 functions.

A memory 230 in the calculator 200 provides storage function for calculator 200. Memory 230 may be of any type of storage device such as for example, Flash memory, Random Access Memory (static and/or dynamic), and other types of electronic and/or mechanical storage devices. A test mode indicator 240 may be configured to indicate whether a test mode is enabled/disabled on the calculator 200. The test mode indicator 240 may be of any form as explained hereinabove. A display 250 provides display function for the calculator 200. The test mode indicator 240 can be integrated in the display 250 to indicate the test mode on the calculator 200. For example, a color scheme of the display 250 may change to indicate test mode enabled, a message may be displayed on display 250 to indicate the test mode. Similarly, fonts and or other display parameters may be changed when the test mode is enabled/disabled on the calculator 200.

The calculator 200 further includes a transceiver 260. In the exemplary illustration, the transceiver 260 is a NFC/RFID transceiver configured to communicate with and scan and read RFID tags such as the RFID tag 275. The transceiver 260 can also be configured to communicate using various wireless communication protocols as explained herein below. The RFID tag 275 may include a radio frequency coil 280 configured to emit predetermined RF signals. The RFID tag 275 further may include a microcontroller unit (MCU) 285. The MCU 285 can be configured to provide controls to generate predetermined signals through the coil 280 to command, instruct, indicate, trigger, or provide similar signals to the calculator 200 to enable a particular mode on calculator 200, enabling/disabling functions on the calculator 200. The processing unit 210 may receive signals from RFID tag 275 via transceiver 260 and execute functions in the calculator 200 such as for example enable/disable a particular mode (e.g., test mode).

While for exemplary illustration, a calculator is described; however, the embodiments described herein can be implemented in any device. For example, functions of any device configured for wireless communication can be remotely monitored and controlled such as various applications on a device (e.g., a mobile phone, computer, appliances, toys, and others) can be enabled/disabled by scanning an RFID tag or by providing wireless commands to the device.

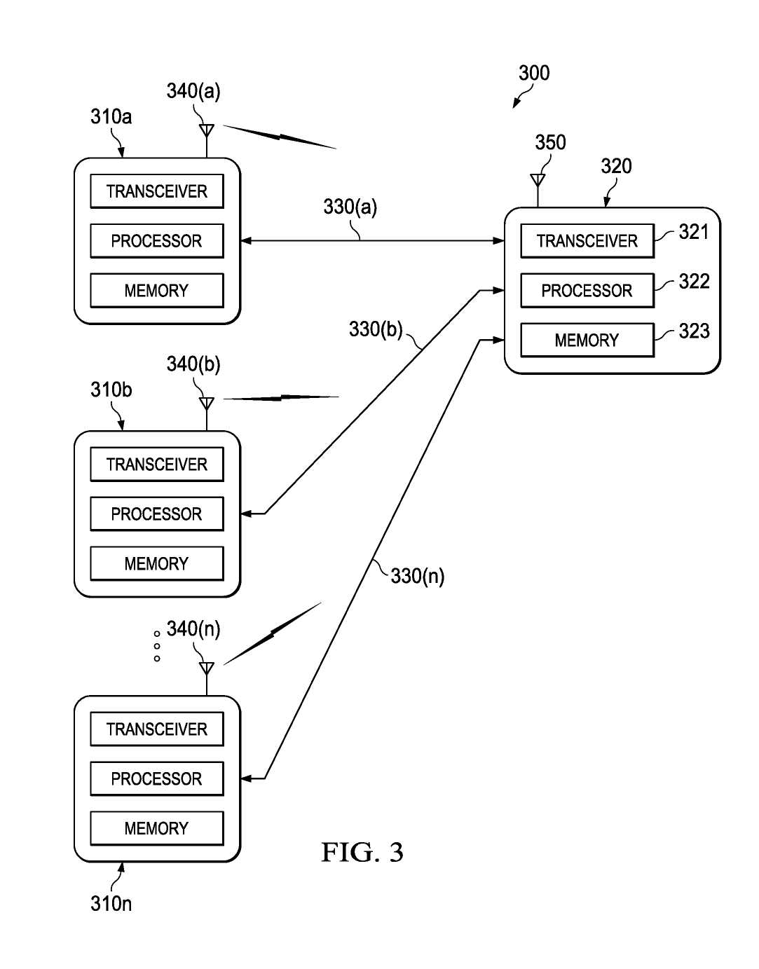

Referring to FIG. 3, an exemplary system 300 for selectively managing functions of devices is illustrated according to an embodiment. The system 300 includes exemplary devices 310(a)-(n). Each exemplary device 310 includes among various other elements, a transceiver, a processor, and a memory. While for simplification and exemplary purposes, only one transceiver, memory, and processor are shown; however, devices 310 may also include various other elements such as for example, multiple processors, multiple transceivers, antennas, interface devices, keyboard, serial/parallel communication interfaces, power connectors, batteries, power management units, display, functional indicators, and various other elements as may be needed for devices 310 to execute intended functions.

The system 300 further includes a central control device 320. The central control device 320 can be any device configured to communicate with devices 310(a)-(n). The central control device 320 includes a transceiver 321, a processor 322, and a memory 323. The central control device 320 may include various other elements also such as for example, multiple processors, multiple transceivers, antennas, interface devices, keyboard, serial/parallel communication interfaces, power connectors, batteries, power management units, display, functional indicators, and various other elements may be needed for central control device 320 to communicate with devices 310(a)-(n) and perform other functions.

The central control device 320 can be any element configured to communicate with devices 310(a-(n). The communication between central control device 320 and devices 310(a-(n) can be either be through wirelines 330(a-(n), proximity based wireless via antennas 340(a-(n) and 350 or a combination thereof. The central control device 320 may provide commands, instructions, indicators, triggers, or similar signals to devices 310(a-(n) to selectively enable/disable certain functions of devices 310(a-(n). According to an embodiment, devices 310(a-(n) may be calculators such as for example calculator 140 as illustrated in FIG. 1 or calculator 200 as illustrated in FIG. 2. The central control device 320 can be a computer (e.g., teacher's computer) configured to enable/disable test mode on calculators 310(a-(n). After a communication link is established between devices 310(a-(n) and central control device 320, the central control device 320 can broadcast general commands for devices 310(a-(n) or provide individual particular commands to devices 310(a-(n) via point-to-point communication to control certain functions of devices 310(a-(n) (e.g., enable/disable test mode).

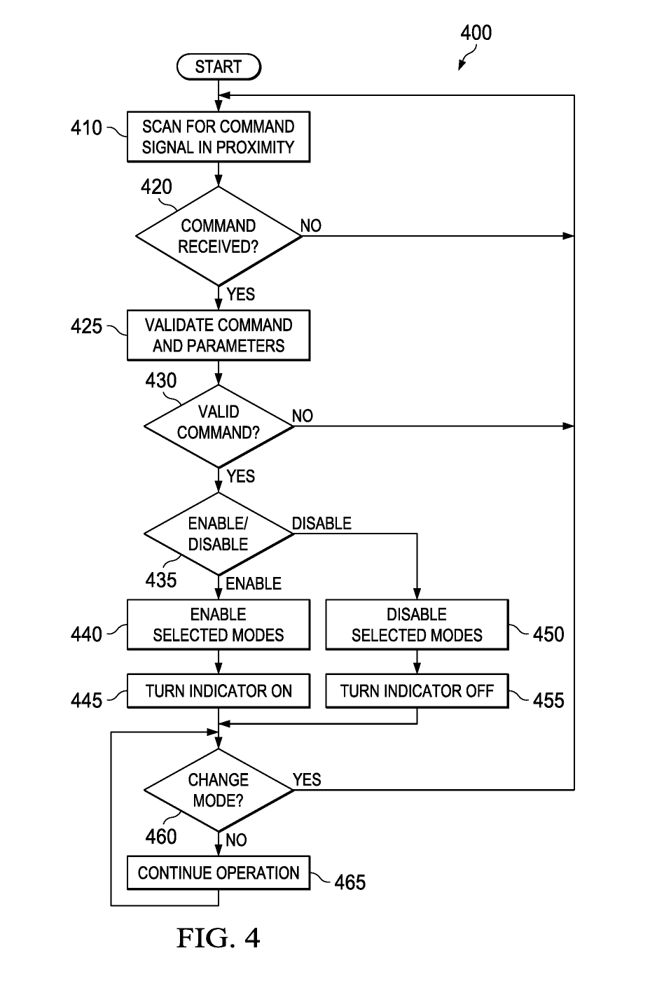

Referring to FIG. 4, an exemplary flowchart 400 of a process for remotely managing functions of devices is illustrated according to an embodiment. At 410, a device (e.g., a calculator) scans proximity for command signals. The proximity scan may include reading signals from an RFID, scanning wireless channels for a particular beacon signal, reading an indicator on a device interface (e.g., connection made using USB or other interfaces). At 420, the device determines if a command is received. If no command is received, then the device continues to scan for commands at 410. If a command is received by the device, then the device validates the command at 425. The command validation may include identifying and authenticating the source of the command for example, the device may validate RFID tag to ensure that the RFID tag is a valid tag. Further, if the command is received via other wireless communications, then the device may authenticate the source of the command for example, by authenticating a digital signature of the source. Various other known authentication methods can also be used to authenticate the source of the command.

At 430, the device determines whether the command is valid. If the command is not valid, then the device may ignore the command and continue to scan for command signals at 410. If the command is validated, then at 435, the device determines whether the command is to enable or disable certain functional modes. The device may have various functional modes, which can be selectively enabled/disabled. For example, the device may store a list of functions that can be selectively enabled/disabled in a given mode. In an embodiment, if the device is a calculator, then the command may instruct the calculator to enable/disable various test modes. For example, if the calculator is being used in a Physics exam, then the command may instruct calculator to enable a first test mode, disabling a first subset of functions in the first test mode, and if the calculator is being used in a Chemistry exam, then the command may instruct the calculator to enable a second test mode, disabling a second subset of functions in the second test mode. Alternatively, the command may instruct the calculator to enable/disable a predetermined number of test modes affecting a predetermined number of corresponding functions in the calculator.

The selection of subset of functions can be predetermined and preconfigured in the device or can be dynamically configured by the commands received. In exemplary embodiment, the command received by the device can include codes, indicators, instructions, or similar signals corresponding to individual functions in the device that can be selectively enabled/disabled or may correspond to a group of functions that can be selectively enabled/disabled. If at 435, the device determines that the command is for enabling selected mode(s), then at 440, the device enables the selected mode(s) such as for example, enabling a test mode in a calculator. The device at 445 turns an indicator ON indicating enabling of the selected mode(s) as described hereinabove.

When at 435 the device determines that the command is to disable selected mode(s), then at 450, the device disables selected mode(s) and at 455 turns an indicator OFF indicating the disabling of selected mode(s). At 460, the device determines whether a change in the operational mode is needed. This determination can be made either after a certain period of time has expired since the last change of mode or can be manually forced by pressing certain buttons on the device causing the device to search for commands. In an embodiment, when a calculator is being used in a test mode in certain exams then a timer may be initiated to end the test mode after certain period of time. If a student completes his/her exam early and the timer has not expired, then the student may force the change in the test mode by pressing certain buttons on the calculator. This may cause the calculator to search for commands for disabling the test mode. In another embodiment, if the timer expires prior to the exam is over, then the calculator can be configured to search for command prior to disabling the test mode thus avoiding accidental release of test mode and allowing extra time for exams. As explained herein, the commands to disable the test mode while within the proximity of the exam can be issued by the central control (e.g., a teacher) such as by placing an RFID tag at certain place, which then can be scanned by the calculator or by issuing command(s) using wireless communication protocols. Similarly, if the calculator is in a normal mode (e.g., all functions enabled), then a test mode can be initiated manually by forcing the calculator to search for test mode commands. If a change in the mode is needed, then the device searches for commands at 410. Otherwise at 465, the device continues the operation in the selected mode(s).

The foregoing outlines features of several embodiments so that those of ordinary skill in the art may better understand various aspects of the present disclosure. Those of ordinary skill in the art should appreciate that they may readily use the present disclosure as a basis for designing or modifying other processes and structures for carrying out the same purposes and/or achieving the same advantages of various embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims. Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An apparatus comprising:
a transceiver; and
a processor coupled to the transceiver, the processor is configured to
receive a first command signal via the transceiver, and
change a functional mode of the apparatus in response to the first command signal, wherein the first command signal is received by scanning a first radio frequency transmitting element.

2. The apparatus of claim 1, wherein the change the functional mode of the apparatus further comprising:
validate the first command signal; and
selectively disable a predetermined number of functions of the apparatus if the first command signal is validated.

3. The apparatus of claim 2, wherein the processor is further configured to receive a second command signal via the transceiver;
validate the second command signal; and
enable the selectively disabled predetermined number of functions of the apparatus if the second command signal is validated, wherein the second command is received by scanning a second radio frequency transmitting element.

4. The apparatus of claim 3, wherein the first and second radio frequency transmitting elements are one or more of
Radio Frequency Identification (RFID) tags;
Near Field Communication (NFC) tags; and
proximity cards.

5. The apparatus of claim 3, wherein the first and second radio frequency transmitting elements are configured to communicate via proximity based communication.

6. The apparatus of claim 1, wherein the apparatus is a handheld calculator and the functional mode is changed to a test mode.

7. A method comprising:
receiving a first command signal at a device; and
changing a functional mode of the device in response to the first command signal, wherein the first command signal is received by scanning a first radio frequency transmitting element.

8. The method of claim 7, wherein the changing the functional mode of the device further comprising:
validating the first command signal; and
selectively disabling a predetermined number of functions of the device, if the first command signal is validated.

9. The method of claim 8, further comprising:
receiving a second command signal;
validating the second command signal; and
enabling the selectively disabled predetermined number of functions of the device, if the second command signal is validated, wherein the second command signal is received by scanning a second radio frequency transmitting element.

10. The method of claim 9, wherein the first and second radio frequency transmitting elements are one or more of
Radio Frequency Identification (RFID) tags;
Near Field Communication (NFC) tags; and
proximity cards.

11. The method of claim 7, wherein the device is a handheld calculator and the functional mode of the calculator is changed to a test mode.

12. A handheld calculator comprising:
a transceiver; and
a processor coupled to the transceiver, the processor is configured to receive a first command signal via the transceiver, and
enable a test mode of the handheld calculator in response to the first command signal, wherein the first command signal is received by scanning a first radio frequency transmitting element.

13. The handheld calculator of claim 12, wherein the enable the test mode of the handheld calculator further comprising:
validate the first command signal; and
selectively disable a predetermined number of functions of the handheld calculator if the first command signal is validated.

14. The handheld calculator of claim 13, wherein the processor is further configured to
receive a second command signal via the transceiver;
validate the second command signal; and
enable the selectively disabled predetermined number of functions of the device, if the second command signal is validated, wherein the second command signal is received by scanning a second radio frequency transmitting element.

15. The handheld calculator of claim 14, wherein the first and second radio frequency transmitting elements are one or more of
Radio Frequency Identification (RFID) tags;
Near Field Communication (NFC) tags; and
proximity cards.
